(19) United States
(12) Patent Application Publication
(10) Pub. No.: US 2017/0332428 A1
(43) Pub. Date: Nov. 16, 2017

(54) Device and Method of Communicating with Network

(71) Applicant: HTC Corporation, Taoyuan City (TW)

(72) Inventors: Chih-Hsiang Wu, Taoyuan City (TW); Kundan Tiwari, Taoyuan City (TW)

(21) Appl. No.: 15/592,212

(22) Filed: May 11, 2017

Related U.S. Application Data
(60) Provisional application No. 62/335,707, filed on May 13, 2016.
(60) Provisional application No. 62/337,304, filed on May 16, 2016.

(51) Int. Cl. H04W 76/02; H04W 76/04; H04W 68/00

(52) U.S. Cl. CPC H04W 76/025; H04W 68/005; H04W 76/046

(57) ABSTRACT

A communication device of communicating with a network comprises instructions of establishing a plurality of bearer contexts with the network; initiating a data transmission associated with a first bearer context of the plurality of bearer contexts; transmitting a first Non Access stratum (NAS) request message comprising only a first bearer identity for the first bearer context to the network; receiving a first radio resource control (RRC) message configuring only a data radio bearer (DRB) for the first bearer context from the network, after transmitting the first NAS request message; transmitting a second NAS request message not comprising any bearer identity for the first bearer context to the network; and receiving a second RRC message configuring a plurality of DRBs for the plurality of bearer contexts from the network, after transmitting the second NAS request message.

### CROSS REFERENCE TO RELATED APPLICATIONS

This application claims the benefit of U.S. Provisional Applications No. 62/335,707, filed on May 13, 2016, and No. 62/337,304, filed on May 16, 2016, which are incorporated herein by reference.

### BACKGROUND OF THE INVENTION

### 1. Field of the Invention

The present invention relates to a communication device and a method used in a wireless communication system, and more particularly, to a communication device and method of communicating with a network.

### 2. Description of the Prior Art

A user equipment (UE) establishes a plurality of bearer contexts with a network. The network needs to configure a plurality of bearers for all of the plurality of bearer contexts for the UE, when the UE transmits a Service Request message to the network. However, it is unnecessary to configure the plurality of bearers for all of the plurality of bearer contexts, if the UE intends to transmit data associated with only a bearer context of the plurality of bearer contexts. Accordingly, communication between the UE and the network cannot be performed efficiently.

Thus, how to communicate with the network efficiently is an important problem to be solved.

### SUMMARY OF THE INVENTION

The present invention therefore provides a method and related communication device for communicating with the network to solve the abovementioned problem.

A communication device of communicating with a network comprises a storage unit for storing instructions and a processing circuit coupled to the storage unit. The processing circuit is configured to execute the instructions stored in the storage unit. The instructions comprise establishing a plurality of bearer contexts with the network; initiating a data transmission associated with a first bearer context of the plurality of bearer contexts; transmitting a first Non Access stratum (NAS) request message comprising only a first bearer identity for the first bearer context to the network in response to the initiation; receiving a first radio resource control (RRC) message configuring only a data radio bearer (DRB) for the first bearer context from the network, after transmitting the first NAS request message; transmitting a second NAS request message not comprising any bearer identity for the first bearer context to the network in response to the initiation; and receiving a second RRC message configuring a plurality of DRBs for the plurality of bearer contexts from the network, after transmitting the second NAS request message.

A network of communicating with a plurality of communication devices comprises a storage unit for storing instructions and a processing circuit coupled to the storage unit. The processing circuit is configured to execute the instructions stored in the storage unit. The instructions comprise receiving a first Non Access stratum (NAS) request message comprising only a bearer identity for a bearer context; transmitting a first radio resource control (RRC) message configuring only a data radio bearer (DRB) for the bearer context, after receiving the first NAS request message; receiving a second NAS request message not comprising any bearer identity; and transmitting a second RRC message configuring a plurality of DRBs for a plurality of bearer contexts, after receiving the second NAS request message.

A network of communicating with a communication device comprises a storage unit for storing instructions and a processing circuit coupled to the storage unit. The processing circuit is configured to execute the instructions stored in the storage unit. The instructions comprise transmitting a paging message comprising a bearer identity to the communication device; receiving a Non Access stratum (NAS) request message comprising the bearer identity; and transmitting a radio resource control (RRC) message configuring a data radio bearer (DRB) for the bearer context in response to the NAS request message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

### DETAILED DESCRIPTION

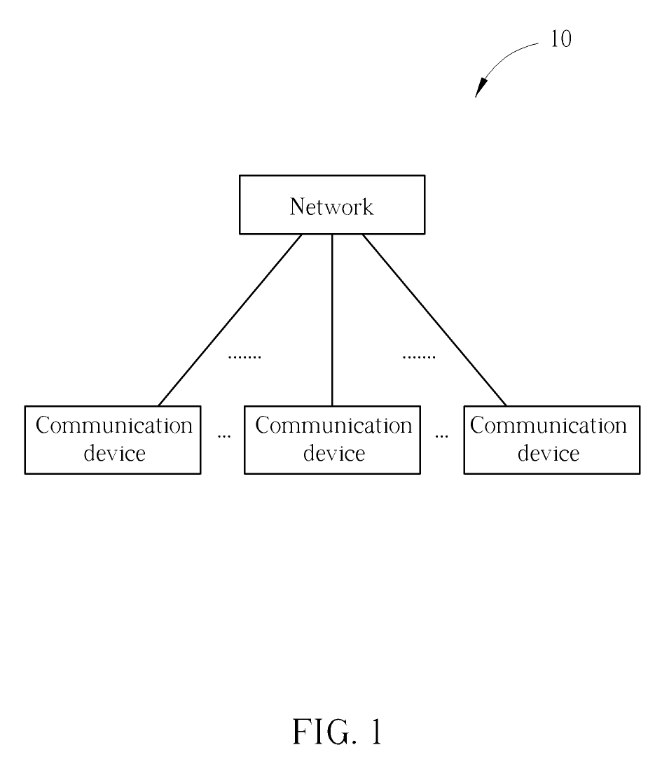

FIG. 1 is a schematic diagram of a wireless communication system 10 according to an example of the present invention. The wireless communication system 10 is briefly composed of a network and a plurality of communication devices. In FIG. 1, the network and the communication devices are simply utilized for illustrating the structure of the wireless communication system 10. Practically, the network may be an evolved UTRAN (E-UTRAN) including at least one evolved NB (eNB) or a fifth generation (5G) RAN including at least one 5G base station. Further, the network may also include both the E-UTRAN/5G RAN and a core network (CN), wherein the CN includes network entities such as a Mobility Management Entity (MME), a Serving Gateway (S-GW), a Packet Data Network (PDN) Gateway (P-GW), 5G MME and/or 5G S-GW, etc.

The communication device may be a user equipment (UE), a mobile phone, a laptop, a tablet computer, an electronic book, a portable computer system, a vehicle or an aircraft. For an uplink (UL), the communication device is the transmitter and the network is the receiver, and for a downlink (DL), the network is the transmitter and the communication device is the receiver.

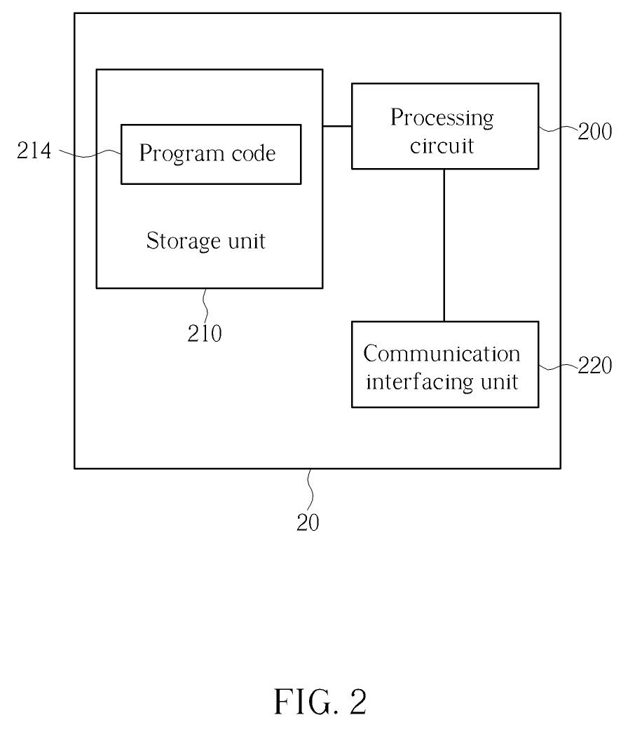

FIG. 2 is a schematic diagram of a communication device 20 according to an example of the present invention. The communication device 20 may be the communication device or the network shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that stores a program code 214, accessed and executed by the processing circuit 200. Examples of the storage unit 210 include but are not limited to a read-only memory (ROM), flash memory, random-access memory (RAM), hard disk, optical data storage device, non-volatile storage unit, non-transitory computer-readable medium (e.g., tangible media), etc. The communication interfacing unit 220 includes a transceiver used to transmit and receive signals (e.g., data, signals, messages and/or packets) according to processing results of the processing circuit 200.

In the following diagrams and examples, a UE is used for representing the communication device in FIG. 1, to simplify the illustration of the examples.

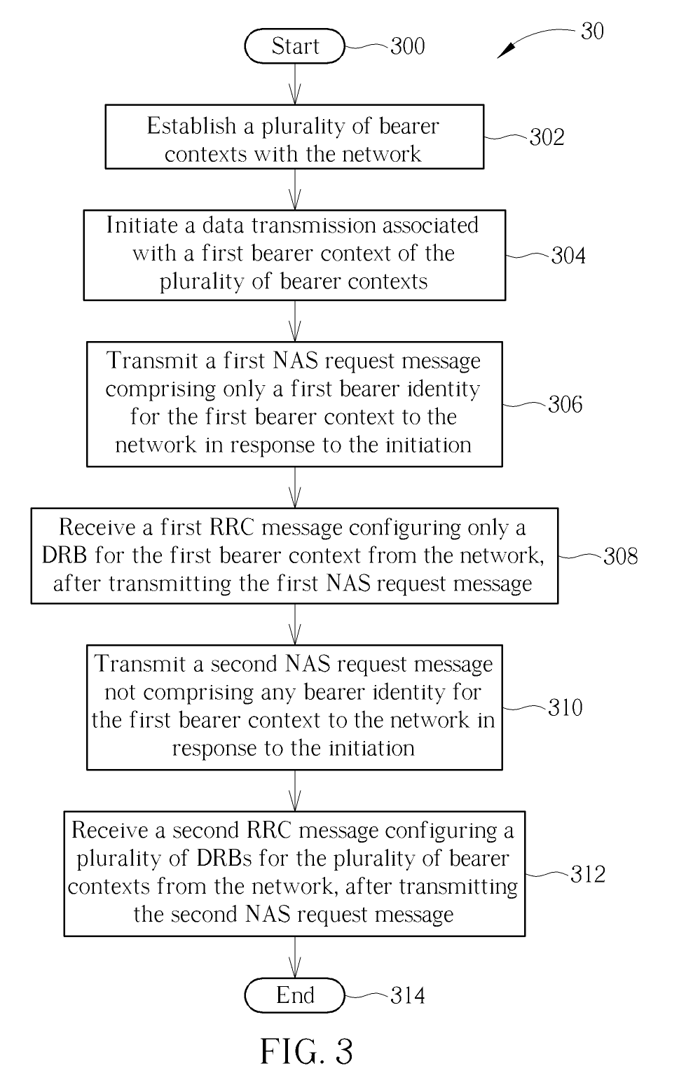

FIG. 3 is a flowchart of a process 30 according to an example of the present invention. The process 30 is utilized in a UE (e.g., the communication device in FIG. 1), to communicate with a network (e.g., the network in FIG. 1). The process 30 includes the following steps:

Step 300: Start.

Step 302: Establish a plurality of bearer contexts with the network.

Step 304: Initiate a data transmission associated with a first bearer context of the plurality of bearer contexts.

Step 306: Transmit a first Non Access stratum (NAS) request message comprising only a first bearer identity for the first bearer context to the network in response to the initiation.

Step 308: Receive a first radio resource control (RRC) message configuring only a data radio bearer (DRB) for the first bearer context from the network, after transmitting the first NAS request message.

Step 310: Transmit a second NAS request message not comprising any bearer identity for the first bearer context to the network in response to the initiation.

Step 312: Receive a second RRC message configuring a plurality of DRBs for the plurality of bearer contexts from the network, after transmitting the second NAS request message.

Step 314: End.

According to the process 30, the UE establishes a plurality of bearer contexts with the network, and initiates a data transmission associated with a first bearer context of the plurality of bearer contexts. Then, the UE transmits a first NAS request message including only a first bearer identity for the first bearer context to the network in response to the initiation, and receives a first RRC message configuring only a DRB for the first bearer context from the network after transmitting the first NAS request message. Further, the UE transmits a second NAS request message not including any bearer identity for the first bearer context to the network in response to the initiation, and receives a second RRC message configuring a plurality of DRBs for the plurality of bearer contexts from the network after transmitting the second NAS request message. That is, the UE indicates to the network that the first bearer context identified by the first bearer identity has UL data pending for transmission. Accordingly, the network configures only one DRB for the first bearer context. Thus, communication between the UE and the network is performed efficiently.

Realization of the process 30 is not limited to the above description. The following examples may be applied for realizing the process 30.

In one example, the UE transmits the first NAS request message to the network in response to the initiation, when the UE has UL data pending for transmission and associated to the first bearer context only. The UE transmits the second NAS request message to the network in response to the initiation, when the UE has UL data pending for transmission and associated to the first bearer context and a second bearer context of the plurality of bearer contexts.

In one example, the UE transmits the first NAS request message including the first bearer identity for the first bearer context to the network in response to the initiation, when the network supports a Cellular Internet of Thing (CIoT) optimization. In one example, the UE transmits the second NAS request message not including any bearer identity for the first bearer context to the network in response to the initiation, when the network does not support the CIoT optimization. That is, the UE determines whether to transmit the bearer identity according to whether the network supports the CIoT optimization.

In one example, the UE determines that the network supports the CIoT optimization, when the UE receives a NAS message (e.g., “Attach Accept” or “Tracking Area Update Accept”) indicating a support of the CIoT optimization. In one example, the UE determines that the network supports the CIoT optimization, when the UE receives a broadcast message (e.g., system information) indicating a support of the CIoT optimization.

In one example, the CIoT optimization includes a Control Plane (CP) CIoT optimization, a User Plane (UP) CIoT optimization or an attach without PDN connection establishment. In one example, the CIoT optimization includes a transmission request for pending a data transmission associated with a bearer context of the plurality of bearer contexts. That is, the network can handle (e.g., support) the first NAS request message. The network may transmit “transmission request for pending data of a bearer context” in a broadcast message (e.g., system information) or in a NAS message (e.g., “Attach Accept” or “Tracking Area Update Accept”).

In one example, the UE establishes the plurality of bearer contexts with the network by transmitting at least one PDN Connectivity Request message and/or at least one Bearer Resource Allocation Request message to the network. In one example, the network transmits at least one “ACTIVATE DEFAULT EPS BEARER CONTEXT REQUEST” message to the UE in response to the at least one PDN Connectivity Request message, and transmits at least one “ACTIVATE DEDICATED EPS BEARER CONTEXT REQUEST” message to the UE in response to the at least one Bearer Resource Allocation Request message.

In one example of Step 308, the first RRC message may not configure another DRB for a second bearer context of the plurality of bearer contexts. In one example, the UE may not deactivate (e.g., locally) any bearer context of the plurality of bearer contexts, which does not have a DRB established when a first NAS request procedure initiated by a transmission of the first NAS request message is completed (e.g., successfully).

In one example, the UE transmits a third NAS request message to the network, when receiving a paging message. The third NAS request message may not include any bearer identity indicating data pending for transmission. In one example, the UE may not deactivate (e.g., locally) any bearer context of the plurality of bearer contexts, which does not have a DRB established when a third NAS request procedure initiated by a transmission of the third NAS request message is completed (e.g., successfully).

In one example, the UE transmits the second NAS request message not including any bearer identity for the first bearer context to the network in response to the initiation, when the network supports the CIoT optimization (e.g., when the UE intends the network to configure the plurality of DRBs for all of the plurality of bearer contexts identified by a plurality of bearer identities). In one example, the UE deactivates (e.g., locally) at least one bearer context of the plurality of bearer contexts, which does not have a DRB established when a second NAS request procedure initiated by a transmission of the second NAS request message is completed (e.g., successfully).

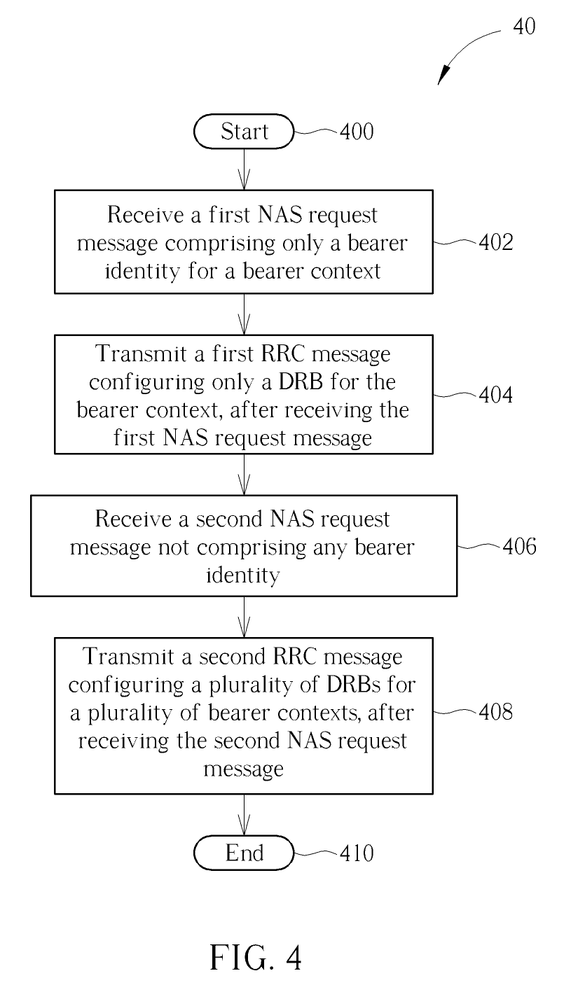

FIG. 4 is a flowchart of a process 40 according to an example of the present invention. The process 40 is utilized in a network (e.g., the network in FIG. 1), to communicate with a plurality of UEs (e.g., the communication devices in FIG. 1). The process 40 includes the following steps:

Step 400: Start.

Step 402: Receive a first NAS request message comprising only a bearer identity for a bearer context.

Step 404: Transmit a first RRC message configuring only a DRB for the bearer context, after receiving the first NAS request message.

Step 406: Receive a second NAS request message not comprising any bearer identity.

Step 408: Transmit a second RRC message configuring a plurality of DRBs for a plurality of bearer contexts, after receiving the second NAS request message.

Step 410: End.

According to the process 40, the network receives a first NAS request message including only a bearer identity for a bearer context, and transmits a first RRC message configuring only a DRB for the bearer context after receiving (e.g., in response to) the first NAS request message. Then, the network receives a second NAS request message not including any bearer identity, and transmits a second RRC message configuring a plurality of DRBs for a plurality of bearer contexts after receiving (e.g. in response to) the second NAS request message. That is, the network is indicated by the UE that the bearer context identified by the bearer identity has UL data pending for transmission. Accordingly, the network configures only one DRB for the bearer context. Thus, communication between the UE and the network is performed efficiently.

Realization of the process 40 is not limited to the above description. The following examples may be applied for realizing the process 40.

In one example, the network supports the CIoT optimization and indicates a support of the CIoT optimization (e.g., in a NAS message or a broadcast message) as described in process 30 and related examples.

In one example, the network receives the first NAS request message and the second NAS request message from a first UE of the plurality of UEs. The network establishes a plurality of bearer contexts with the first UE, and the first bearer context is one of the plurality of bearer contexts. The first UE may transmit the first NAS request message to initiate a data transmission associated with the first bearer context of the plurality of bearer contexts. The first UE may transmit the second NAS request message to initiate a data transmission associated with the plurality of bearer contexts. The network may transmit the first RRC message and the second RRC message to the first UE.

In one example, the network receives the first NAS request message from a first UE of the plurality of UEs, and transmits the first RRC message to the first UE. The network receives the second NAS request message from a second UE of the plurality of UEs, and transmits the second RRC message to the second UE. The network establishes a first plurality of bearer contexts with the first UE. The network establishes a second plurality of bearer contexts with the second UE. The first UE may support the CIoT optimization, and may transmit the first NAS request message to initiate a data transmission associated with the first bearer context of the first plurality of bearer contexts. The network transmits the first RRC message to the first UE in response to the first NAS request message. In one example, the second UE supports the CIoT optimization, and transmits the second NAS request message to initiate data transmission associated with the second plurality of bearer contexts. In another example, the second UE may not support the CIoT optimization, and transmits the second NAS request message to initiate the data transmission associated with the second plurality of bearer contexts. The second plurality of bearer contexts may include all of bearer contexts established by the second UE with the network. The network transmits the second RRC message to the second UE in response to the second NAS request message.

In one example of the processes above, the first NAS request message is a Service Request message, an Extended Service Request message or a Data Service Request message, the second NAS request message is a Service Request message, and the third NAS request message is an Extended Service Request message, a Data Service Request message or a Service Request message.

In one example of the processes above, the first RRC message and the second RRC message are RRC Connection Reconfiguration messages. The UE transmits a RRC Connection Reconfiguration Complete message to the network in response to a RRC Connection Reconfiguration message. The first RRC message may include the first bearer identity. The second RRC message may include a plurality of bearer identities for the (or second) plurality of bearer contexts. The (or second) plurality of bearer contexts may include all of the (or second) plurality of bearer contexts established by the first/second UE with the network.

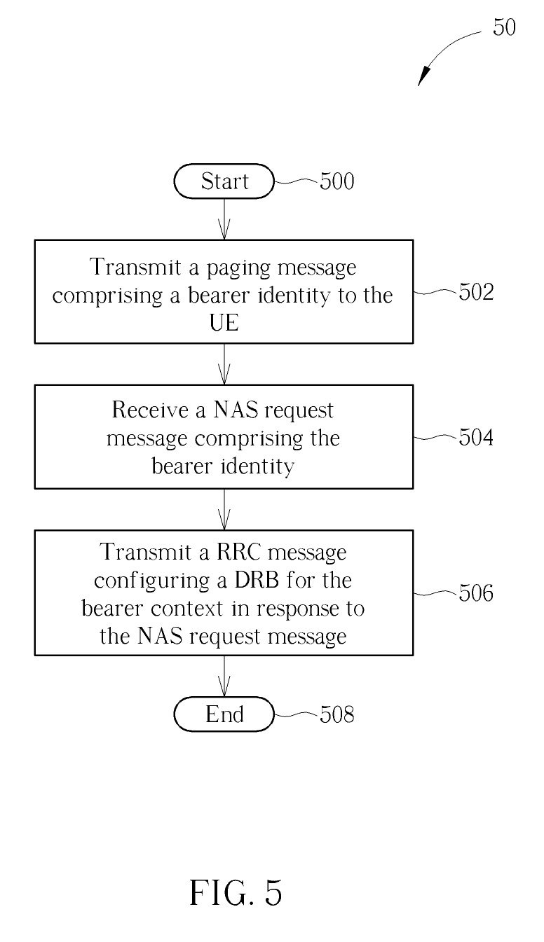

FIG. 5 is a flowchart of a process 50 according to an example of the present invention. The process 50 is utilized in a network (e.g., the network in FIG. 1), to communicate with a UE (e.g., the communication device in FIG. 1). The process 50 includes the following steps:

Step 500: Start.

Step 502: Transmit a paging message comprising a bearer identity to the UE.

Step 504: Receive a NAS request message comprising the bearer identity.

Step 506: Transmit a RRC message configuring a DRB for the bearer context in response to the NAS request message.

Step 508: End.

According to the process 50, the network pages the UE with a bearer identity for a bearer context established between the UE and network. When the UE receives the bearer identity, the UE obtains that the network intends to transmit data associated with the bearer context to the UE and transmits the NAS request message including the bearer identity to the network. The network transmits a RRC message configuring a DRB for the bearer context in response to the NAS request message. Thus, when the network receives the NAS request message from the UE, both the network and the UE communicate with each other operated according to the processes 30 and/or 40.

In one example of the processes above, the bearer identity is an Evolved Packet System (EPS) bearer identity and the bearer context is an EPS bearer context. In another example, the bearer identity is a 5G bearer identity and the bearer context is a 5G bearer context.

It should be noted that although the above examples are illustrated to clarify the related operations of corresponding processes. The examples can be combined and/or modified arbitrarily according to system requirements and/or design considerations.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means be the communication device 20. Any of the abovementioned processes may be compiled into the program code 214.

To sum up, the present invention provides a method and related communication device for communicating with a network. Accordingly, the network configures only one DRB for the bearer context identified by the bearer identity indicated by the UE. Thus, communication between the UE and the network is performed efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device of communicating with a network, comprising:
a storage unit for storing instructions of:
establishing a plurality of bearer contexts with the network;
initiating a data transmission associated with a first bearer context of the plurality of bearer contexts;
transmitting a first Non Access stratum (NAS) request message comprising only a first bearer identity for the first bearer context to the network in response to the initiation;
receiving a first radio resource control (RRC) message configuring only a data radio bearer (DRB) for the first bearer context from the network, after transmitting the first NAS request message;
transmitting a second NAS request message not comprising any bearer identity for the first bearer context to the network in response to the initiation; and
receiving a second RRC message configuring a plurality of DRBs for the plurality of bearer contexts from the network, after transmitting the second NAS request message; and
a processing circuit, coupled to the storage unit, configured to execute the instructions stored in the storage unit.

2. The communication device of claim 1, wherein the communication device transmits the first NAS request message comprising only the first bearer identity for the first bearer context to the network in response to the initiation when the network supports a Cellular Internet of Thing (CIoT) optimization, and transmits the second NAS request message not comprising any bearer identity for the first bearer context to the network in response to the initiation when the network does not support the CIoT optimization.

3. The communication device of claim 2, wherein the communication device determines that the network supports the CIoT optimization, when the communication device receives a NAS message indicating a support of the CIoT optimization or receives a broadcast message indicating a support of the CIoT optimization.

4. The communication device of claim 2, wherein the CIoT optimization comprises a Control Plane (CP) CIoT optimization, a User Plane (UP) CIoT optimization or an attach without Packet Data Network (PDN) connection establishment.

5. The communication device of claim 1, wherein the instruction of establishing the plurality of bearer contexts with the network comprises:
transmitting at least one PDN Connectivity Request message and/or at least one Bearer Resource Allocation Request message to the network.

6. The communication device of claim 1, wherein the first RRC message does not configure another DRB for a second bearer context of the plurality of bearer contexts.

7. The communication device of claim 1, wherein the storage unit further stores the instruction of:
not deactivating any bearer context of the plurality of bearer contexts, which does not have a DRB established when a first NAS request procedure initiated by a transmission of the first NAS request message is completed; and
deactivating at least one bearer context of the plurality of bearer contexts, which does not have the DRB established when a second NAS request procedure initiated by a transmission of the second NAS request message is completed.

8. The communication device of claim 1, wherein the first NAS request message is a Service Request message, an Extended Service Request message or a Data Service Request message, the second NAS request message is the Service Request message, and the first RRC message and the second RRC message are RRC Connection Reconfiguration messages.

9. The communication device of claim 1, wherein the communication device transmits the first NAS request message to the network in response to the initiation, when the UE has UL data pending for transmission and associated to the first bearer context only; and the communication device transmits the second NAS request message to the network in response to the initiation, when the UE has UL data pending for transmission and associated to the first bearer context and a second bearer context of the plurality of bearer contexts.

10. A network of communicating with a plurality of communication devices, comprising:
a storage unit for storing instructions of:
receiving a first Non Access stratum (NAS) request message comprising only a bearer identity for a bearer context;
transmitting a first radio resource control (RRC) message configuring only a data radio bearer (DRB) for the bearer context, after receiving the first NAS request message;
receiving a second NAS request message not comprising any bearer identity; and
transmitting a second RRC message configuring a plurality of DRBs for a plurality of bearer contexts, after receiving the second NAS request message; and
a processing circuit, coupled to the storage unit, configured to execute the instructions stored in the storage unit.

11. The network of claim 10, wherein the network receives the first NAS request message and the second NAS request message from a first communication device of the plurality of communication devices, and transmits the first RRC message and the second RRC message to the first communication device.

12. The network of claim 10, wherein the network receives the first NAS request message from a first communication device of the plurality of communication devices and transmits the first RRC message to the first communication device in response to the first NAS request message, and receives the second NAS request message from a second communication device of the plurality of communication devices and transmits the second RRC message to the second communication device in response to the second NAS request message.

13. The network of claim 10, wherein the first NAS request message is a Service Request message, an Extended Service Request message or a Data Service Request message, the second NAS request message is the Service Request message, and the first RRC message and the second RRC message are RRC Connection Reconfiguration messages.

14. A network of communicating with a communication device, comprising:
a storage unit for storing instructions of:
transmitting a paging message comprising a bearer identity to the communication device;
receiving a Non Access stratum (NAS) request message comprising the bearer identity; and
transmitting a radio resource control (RRC) message configuring a data radio bearer (DRB) for the bearer context in response to the NAS request message; and
a processing circuit, coupled to the storage unit, configured to execute the instructions stored in the storage unit.
